(19) United States
(12) Patent Application Publication
(10) Pub. No.: US 2007/0071467 A1
(43) Pub. Date: Mar. 29, 2007

(54) Image formation apparatus

(76) Inventors: Teruaki Mitsuya, Ibaraki (JP); Masahiro Yagi, Ibaraki (JP); Toshio Ogiso, Ibaraki (JP); Shunichi Oohara, Ibaraki (JP); Shigeru Obata, Ibaraki (JP); Toru Hanashima, Ibaraki (JP); Osamu Saito, Ibaraki (JP)

Correspondence Address: LADAS & PARRY LLP, 224 SOUTH MICHIGAN AVENUE, SUITE 1600, CHICAGO, IL, 60604, US

(21) Appl. No.: 11/477,023

(22) Filed: Jun. 28, 2006

(30) Foreign Application Priority Data
Sep. 26, 2005 (JP) 2005-278378

(51) Int. Cl. G03G 15/00; G03G 15/20

(52) U.S. Cl. 399/45; 399/69

(57) ABSTRACT

An image formation apparatus is disclosed. The image formation apparatus includes a fixing unit whose heater temperature is controlled to be in a non-offsetting range so that no offset is produced, the non-offsetting range being defined for each different paper thickness. Nip time remains constant even when the thickness of the paper to be printed on next is changed. Printing is suspended until the heater temperature, approaching the non-offsetting range, reaches an inconspicuous offset range on either side of the non-offsetting range, inconspicuous offset being produced if printing is performed in the inconspicuous offset range.

### BACKGROUND OF THE INVENTION

1. Field of the Invention

The present invention generally relates to an image formation apparatus, and especially relates to an image formation apparatus that is configured so that a toner image imprinted on a surface of a recording object may be fixed to the recording object.

2. Description of the Related Art

The image formation apparatus uses an electrophotography method to develop a latent image into a visible image with colored particles, imprint the visible image on a surface of a recording form (recording object), and fix the visible image to the recording form. A powder called toner prepared for electrophotography is used as the colored particles. The toner is fused by heating and solidified by cooling. The fixing process uses this property of the toner, i.e., the toner is fused onto the recording form and cooled to be fixed to the recording form.

According to a conventional fixing unit for fixing the toner image imprinted on the recording form, a heating roller is heated by a halogen heater provided inside the heating roller; a pressure roller is pressed to the heating roller by, e.g., a coil spring; a nip section is formed between the heating roller and the pressure roller; the recording form, onto which the toner is adhering, is passed through the nip section; and the toner image is fixed (for example, Patent Reference 1).

However, according to the method wherein the rollers make forced contact, as a fast operating speed is required, it is necessary to increase a heating distance (period) for heating the toner image on the recording form. For this purpose, a fixing unit is proposed (for example, Patent Reference 2) wherein a belt (endless belt) counters the heating roller, is rotatable, and has a surface that is capable of elastic deformation. The belt is driven in a conveyance direction, and the nip section for pressing the recording form to the heating roller is formed by pressing the belt with a pressurization member. This fixing unit is called a belt-nip type fixing unit for fixing the toner image on the recording form that is provided between the belt and the heating roller by heating and pressing.

[Patent reference 1]

Japanese Patent No. 2875423

[Patent reference 2]

Japanese Patent No. 3298354

### Description of the Invention

### Problem(s) to be solved by the Invention

Nevertheless, if an image formation apparatus employs the fixing unit of the belt-nip type as described above, the ability to increase a nip time, which is a period during which the recording form passes through the nip, causes the following problems.

If the nip time is long, since a considerable amount of heat is transmitted toward the back (opposite side of the surface on which the toner image is adhered) of the recording form, the amount of heat provided to the toner differs with the thickness of the recording form (paper thickness). Conversely, if the nip time is short, the heat does not reach the back. In this case, the thermal capacity of the recording form can be considered infinite regardless of the thickness of the recording form, and the amount of heat provided to the toner is the same irrespective of the paper thickness.

That is, in the case wherein the nip time is long, since the propagation distance of effective heat becomes greater than the paper thickness, the amount of heat provided to the toner depends on the paper thickness. For this reason, in order to keep the amount of heat constant, it is necessary to adjust the nip time according to the paper thickness. Accordingly, when the paper is thin, the nip time is shortened, and when the paper is thick, the nip time is made greater.

In order to adjust the nip time according to the paper thickness, two methods are conceived; namely, a method wherein the speeds of all the processes including a development process are changed, and another method wherein the speed of only the fixing process section is changed. According to the former method, adjustments of not only paper conveyance but also development and imprint processes are required; for this reason, the reliability of the whole process is likely to be degraded. Further, the printing speed varies with the paper thickness, which is inconvenient for users.

According to the latter method, the conveyance speed while imprinting is different from the conveyance speed while fixing, and the conveyance path between an imprint position and a fixing position becomes longer than at least the paper length, so that a form gap (paper interval) serves as a buffer. This increases the dimensions of the image formation apparatus, and is likely to degrade the reliability of paper conveyance because of the conveyance speed difference between imprinting and fixing.

Further, the reason why the nip time has to be adjusted depending on the paper thickness in the conventional image formation apparatus using the fixing unit of the belt nip method is to keep the amount of heat provided to the toner image constant. It is conceivable that the amount of heat can be kept constant by controlling the temperature of the heating roller depending on the paper thickness. However, it takes a long time to change the temperature. For example, if the temperature that is relatively low for thin paper is now to be raised for thick paper, the temperature cannot be raised as quickly as desired; for this reason, a low-temperature offset problem occurs in early sheets of fixing on thick paper.

As described above, the problems with the conventional image formation apparatus of the belt nip method include that, in the case where the conveyance speed of the recording form is changed, the printing speed is changed depending on the thickness of the recording form, which is inconvenient; and that, in the case where the conveyance speed of the recording form is fixed and the temperature of the heating roller is changed according to the thickness of the recording form, an offset is produced.

### SUMMARY OF THE INVENTION

The present invention may provide an image formation apparatus that substantially obviates one or more of the problems caused by the limitations and disadvantages of the related art.

More specifically, an embodiment of the present invention provides an image formation apparatus that is capable of fixing a toner image without changing nip time irrespective of the thickness of a recording object to be recorded on next.

Features of embodiments of the present invention are set forth in the description that follows, and in part will become apparent from the description and the accompanying drawings, or may be learned by practice of the invention according to the teachings provided in the description. Problem solutions provided by an embodiment of the present invention will be realized and attained by an image formation apparatus particularly pointed out in the specification in such full, clear, concise, and exact terms as to enable a person having ordinary skill in the art to practice the invention.

### Means for Solving the Problem

To achieve these solutions and in accordance with an aspect of the invention, as embodied and broadly described herein, an embodiment of the invention provides an image formation apparatus as follows.

According to an aspect of the invention, the image formation apparatus is an electrophotography recording device that includes an image forming unit for forming a toner image on a recording object, and a fixing unit of a belt nip method that includes a heating roller for fixing the toner image to the recording object, wherein a temperature of the heating roller is set in a non-offsetting range corresponding to the thickness of the recording object, and when the thickness of the recording object is changed (when the recording objects to be printed on next have a thickness different from that of the previous object printed on), a first sheet after changing is processed while the temperature of the heating roller is in an inconspicuous offset range that is adjacent to the non-offsetting range.

According to another aspect of the invention, a nip time of the fixing unit is defined such that a square root of a product of a thermal diffusivity of the recording object and the nip time is greater than the thickness of the recording object.

According to another aspect of the invention, when the thickness of the recording object is changed, the nip time of the fixing unit is not changed.

According to another aspect of the invention, the image formation apparatus is characterized in that a distance from a final imprinting unit to the fixing unit is shorter than a length of the recording object in the conveyance direction.

According to another aspect of the invention, a non-image side pressurization member of the fixing unit is singular.

### Effect of the Invention

According to the present invention, the toner image is fixed by the fixing unit that uses the belt nip method. The temperature of the heating roller of the fixing unit is set in the non-offsetting range corresponding to the thickness of the recording object. When the thickness of the recording object is changed, the first sheet after changing is processed while the temperature of the heating roller is in the inconspicuous offset range that is adjacent to the non-offsetting range. In this way, low-temperature offset is not produced even though a minimal quantity of inconspicuous offset may be produced when the recording object is changed from thin paper to thick paper. Accordingly, printing speed is maintained even when the paper thickness is changed, raising the reliability and availability of the image formation apparatus without producing offset.

Further, since the square root of the product of the thermal diffusivity and the nip when the recording object passes the nip is made greater than the thickness of the recording object, the heat transfer region can be made the same irrespective of the thickness of the recording object.

Further, when changing between recording objects of different thicknesses, the nip time is not changed but kept constant; accordingly, the conveyance speed of the recording objects is maintained, providing high-speed printing.

Further, according to an embodiment of the present invention, since the distance from the final imprinting unit to the fixing unit is made shorter than the length of the recording object in the conveyance direction, the image formation apparatus can be miniaturized.

Further, since the non-image side pressurization member of the fixing unit using the belt nip method is singular (one contact member), heat transfer from the heating roller to the recording object when changing the heating temperature according to the paper thickness can be efficiently carried out, there being no drop in pressure applied to the recording object by the heating roller; accordingly, the toner image can be stably fixed.

### BRIEF DESCRIPTION OF THE DRAWINGS

FIG. 1 is a side elevation view of an image formation apparatus using a fixing unit according to an embodiment of the present invention;

FIG. 2 is a side elevation view of a fixing unit 40 that is schematically shown;

FIG. 3A is a cutaway view showing a heat transfer situation in fixing wherein a nip time is short, and a recording form P is thin;

FIG. 3B is a cutaway view showing the heat transfer situation in fixing wherein the nip time is short, and the recording form P is thick;

FIG. 4A is a cutaway view showing the heat transfer situation in fixing wherein the nip time is long, and the recording form P is thin;

FIG. 4B is a cutaway view showing the heat transfer situation in fixing wherein the nip time is long, and the recording form P is thick;

FIG. 5 is a cutaway view showing the heat transfer situation in the direction of the thickness of the recording form P when the nip time is extended;

FIG. 6 is a graph showing the relationship between the temperature of a heating roller 41 and an amount of offset produced;

FIG. 7 is a table showing the relationships between the heating roller temperature and the amount of offset produced in the cases of fixing on thin paper and thick paper;

FIG. 8 is a flowchart for explaining a heating roller temperature control process 1 performed by a control unit 19;

FIG. 9 is a table showing the relationships between the heating roller temperature and the amount of offset produced in the cases of selectively conveying and fixing on super-thin paper, thin paper, and thick paper; and

FIG. 10 is a flowchart for explaining a heating roller temperature control process 2 performed by the control unit 19.

### DESCRIPTION OF THE PREFERRED EMBODIMENTS

In the following, embodiments of the present invention are described with reference to the accompanying drawings.

[Embodiment 1]

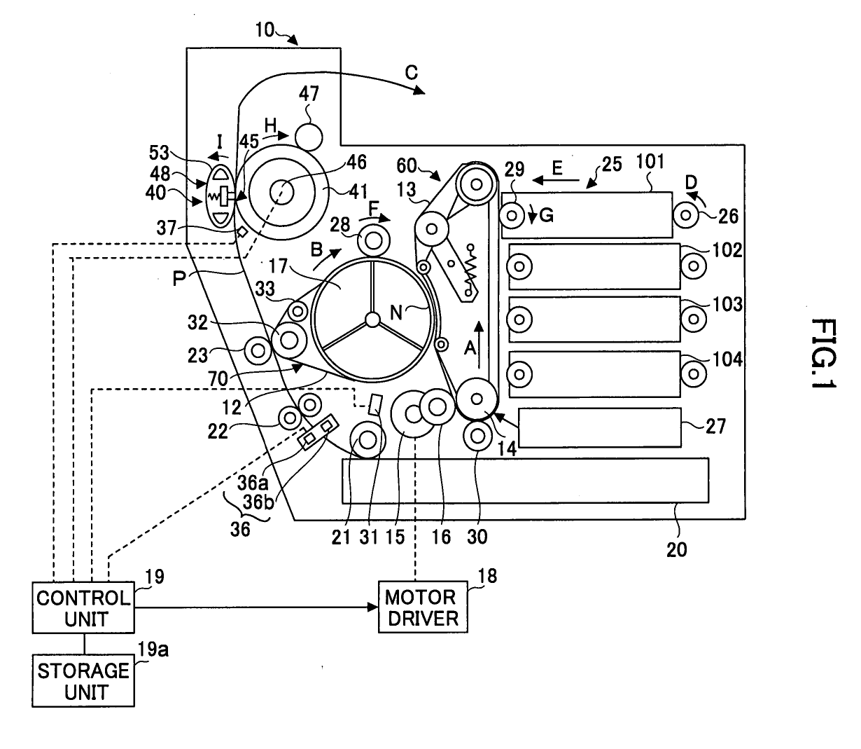

FIG. 1 is a side elevation view of an image formation apparatus 10 according to Embodiment 1 of the present invention. As shown in FIG. 1, the image formation apparatus 10 is a color laser printer capable of forming a color image wherein images in four colors are superposed by a middle imprint belt 12 rotating four revolutions.

The image formation apparatus 10 includes a form cassette (paper feed unit) 20, a developing unit (development means) 25, a fixing unit 40, a photo-conductive belt unit 60, and a middle imprint belt unit (imprint means) 70.

The photo-conductive belt unit 60 includes a photo-conductive belt 13, on which a toner image is formed by the developing unit 25. The photo-conductive belt 13 is conveyed in a direction indicated by an arrow A by a photo-conductive belt driving roller 14 that is driven by a driving motor 15 through a motor drive system 16. The middle imprint belt 12 is driven by conveyance power of a nip section N in contact with the photo-conductive belt 13. Further, the driving motor 15 is controlled to maintain a fixed rotational frequency by a motor driver 18.

The middle imprint belt unit 70 includes the middle imprint belt 12, on which the toner image formed on the photo-conductive belt 13 is imprinted. Further, the middle imprint belt 12 is wound around a photo-conductive roller 17 and an imprint roller 32. Further, the photo-conductive belt 13 is pressed against the photo-conductive roller 17 through the middle imprint belt 12.

The developing unit 25 includes developing units 101 through 104 for four colors, namely, black, yellow, magenta, and cyan. While the developing units 101 through 104 store the toner in corresponding colors, a developing roller 29 for forming a thin layer of the toner is arranged at the end of each developing unit, the end countering the photo-conductive belt 13.

The image formation apparatus 10 includes a fur brush 28 for removing remaining toner from the middle imprint belt 12.

The image formation apparatus 10 further includes an imprint roller 23 for imprinting the toner image onto the recording form P, pressing the recording form P to the middle imprint belt 12 in an imprinting process, and for imprinting the toner image on the middle imprint belt 12 onto the recording form P. The form cassette 20 for storing recording forms P is approximately horizontally arranged at a lower part of the image formation apparatus 10.

A form conveyance path C, the middle imprint belt 12, the photo-conductive belt 13, and the developing unit 25 are arranged in the image formation apparatus 10. Further, along the form conveyance path C, the form cassette 20, a pickup roller 21, a resist roller 22, the imprint roller 23, and the fixing unit 40 are arranged.

Between the pickup roller 21 and the resist roller 22, a thickness detection sensor (thickness detection means) 36 for detecting the thickness of the recording form P provided from the form cassette 20 is arranged. The thickness detection sensor 36 includes a luminous source 36a and an optical signal receiving unit 36b. The luminous source 36a irradiates light incident on the recording form P that is conveyed between the luminous source 36a and the optical signal receiving unit 36b, and the optical signal receiving unit 36b receives light that comes through the recording form P. Then, an optical transmission ratio, which is the ratio of the amount of received light to the amount of light irradiated, is obtained. Then, the thickness is determined based on the optical transmission ratio. Here, if the recording form P is colored rather than white, it is possible to detect the thickness by compensating for attenuation due to coloring.

Further, according to this Embodiment, the thickness detection sensor 36 is located between the pickup roller 21 and the resist roller 22 nearby the form cassette 20; for this reason, it is possible to adjust temperature of the fixing unit 40 before the recording form P reaches the fixing unit 40 and after the thickness is determined.

Here, although Embodiment 1 is configured such that the thickness of the recording form P provided by the form cassette 20 is automatically determined using the thickness detection sensor 36, this is not a limitation; it can be configured such that an operator beforehand inputs printing conditions including the thickness of the target recording form P, and a temperature setting unit (temperature setting means) for setting the temperature of the heating roller 41 carries out temperature setting based on the input printing conditions. In this case, the thickness detection sensor 36 can be dispensed with.

A temperature sensor 37 for, in a non-contact manner, detecting the temperature of the heating roller 41 is arranged near the heating roller 41 of the fixing unit 40. The temperature sensor 37 provides a detected temperature signal to a control unit 19. The control unit 19 determines whether the temperature of the heating roller 41 has reached a predetermined temperature (setup temperature).

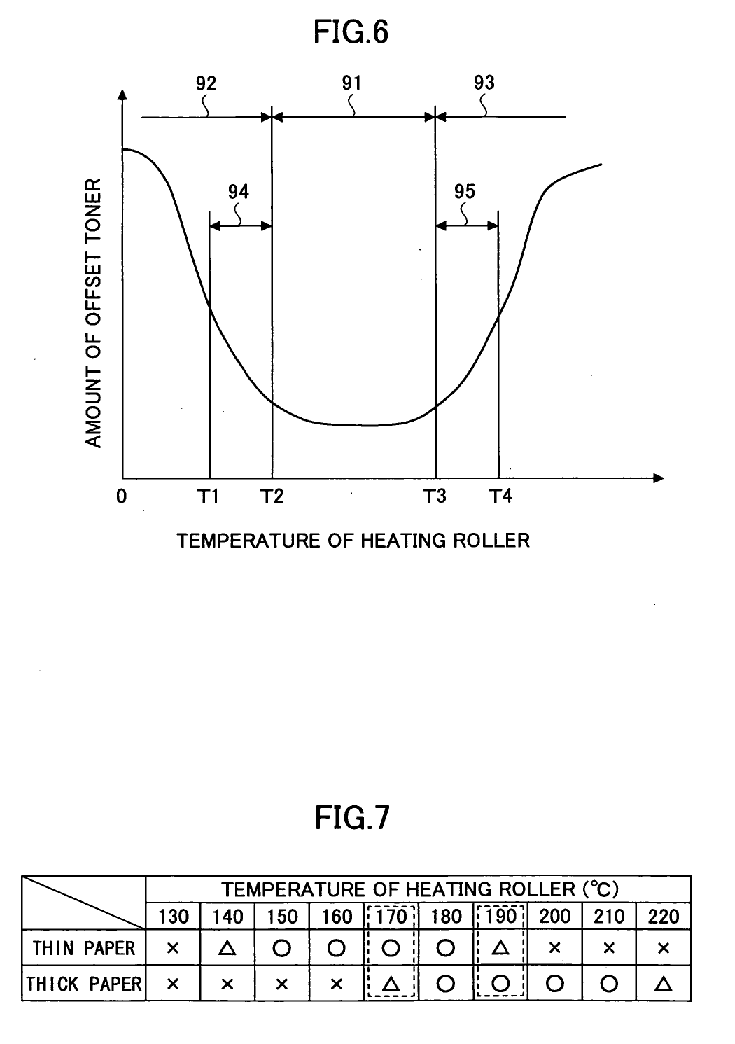

A storage section 19a is connected to the control unit 19, the storage section 19a storing a control program (temperature setting means) for setting the temperature in one of inconspicuous offset ranges (shown in FIG. 6) that are adjacent to a low temperature side and a high temperature side of a non-offsetting range that corresponds to the thickness detected by the thickness detection sensor 36, and another control program (control means) for controlling the temperature of the fixing unit 40 so that the setup temperature is maintained. Further, the storage section 19a stores setup temperature (190° C.) data to be used when changing from thick paper to thin paper, and setup temperature (170° C.) data to be used when changing from thin paper to thick paper.

Next, an image formation process performed by the image formation apparatus 10 is described. When forming an image with the image formation apparatus 10, a photo-conductive layer of the photo-conductive belt 13 is charged by an electrification brush 30, a laser beam according to the image is irradiated onto the photo-conductive layer of the photo-conductive belt 13 from a laser-beam optical unit 27 so that the potential (charge) is removed. Then, the developing roller 29, to which the toner of the developing unit 25 is adhered, is rotated and made to contact the photo-conductive belt 13 so that a toner layer according to the image is formed on the photo-conductive belt 13.

According to the present Embodiment, the toner layer on the photo-conductive belt 13 is next imprinted onto the middle imprint belt 12.

The image formation apparatus 10, according to Embodiment, includes the developing units 101 through 104 for colors of black, yellow, magenta, and cyan, respectively. A color image is formed on the middle imprint belt 12 by superposing images in the colors on the photo-conductive belt 13 color by color.

The recording forms P stored in the form cassette 20 are taken out sheet by sheet by the pickup roller 21, and a skew is rectified by the resist roller 22. Then, the toner image on the middle imprint belt 12 is imprinted onto the recording form P by the imprint roller 23.

Then, the recording form P reaches the fixing unit 40, and the toner image imprinted on the surface of the recording form P is fixed by heat and pressure.

Residual image toner that remains on the middle imprint belt 12 after imprinting is removed by the fur brush 28 rotationally contacting the middle imprint belt 12.

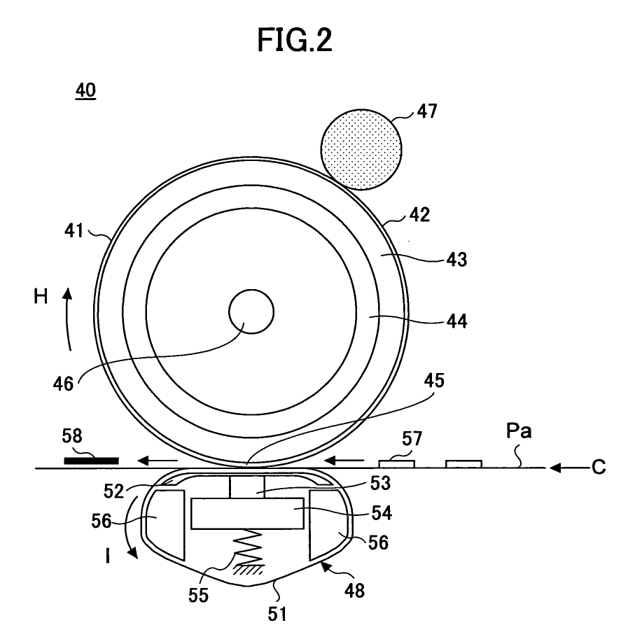

FIG. 2 is a side elevation view schematically showing the fixing unit 40. As shown in FIG. 2, the fixing unit 40 includes a heating roller 41 for heating an image formation side Pa of the recording form P, an electric heater (heat source for fixing) 46 formed at the center of the heating roller 41, a toner cleaner 47 for collecting offset toner adhering to the perimeter of the heating roller 41, and a pressurization belt mechanism 48.

The heating roller 41 is rotationally driven in a direction H by a driving motor (not shown). Further, the heating roller 41 includes a surface covering layer 42 on the perimeter, and an elastic layer 43 formed inside the surface covering layer 42. Further, a metal core layer 44 in the shape of a cylinder is inserted inside of the elastic layer 43, and the electric heater 46 is arranged inside of the metal core layer 44. The control unit 19 controls a voltage provided to the electric heater 46 through a control signal such that a desired temperature is obtained. Accordingly, concerning the heating roller 41, the heat from the electric heater 46 travels through the metal core layer 44, the elastic layer 43, and the surface covering layer 42, then reaches the image formation side Pa of the recording form P traveling through the nip section 45, and the image formation side Pa is heated at a setup temperature.

The pressurization belt mechanism 48 includes a pressurization belt 51 (an endless member arranged on the opposite side to the image formation side, the opposite side being called a non-image side) that constitutes the nip section 45, a low friction member 52 that makes sliding contact with the inside of the pressurization belt 51, a non-image side pressurization pad 53 that contacts the rear side of the low friction member 52, a supporting member 54 for supporting the non-image side pressurization pad 53, a pressurizing coil spring 55 for pressing the supporting member 54, and circular guides 56 arranged before (upstream) and behind (downstream) the low friction member 52 for guiding the pressurization belt 51 that passes the nip section 45 to return to the entrance side of the nip section 45.

The low friction member 52 is provided so that friction between the pressurization belt 51 and the non-image side pressurization pad 53 may be reduced. The pressing force of the pressurizing coil spring 55 is transmitted to the recording form P through the supporting member 54, the non-image side pressurization pad 53, the low friction member 52, and the pressurization belt 51 when the recording form P passes the nip section 45. The transmitted pressing force presses the image formation side Pa of the recording form P to contact the heating roller 41.

While the pressurization belt 51 presses the recording form P to contact the heating roller 41 with the pressing force of the pressurizing coil spring 55, it slides on the surface of the low friction member 52 and runs in the conveyance direction of the recording form P driven by the rotational power of the heating roller 41. Further, while the pressurization belt 51 constitutes a part of the form conveyance way C of the recording form P, it is guided by the circular guide members 56 so that it travels in a direction I and is returned to the entrance side of the nip section 45.

Yet-to-be-fixed toner 57 is imprinted on the image formation side Pa of the recording form P, is heated, and is pressed by the heating roller 41 while passing through the nip section 45. In this way, the yet-to-be-fixed toner 57 becomes a fixed image 58. Accordingly, heating temperature and nip time are of concern when fixing the yet-to-be-fixed toner 57 imprinted on the recording form P to the recording form P, the nip time being a time interval during which the recording form P passes through the nip section 45. Here, the nip time is defined by the conveyance speed of the recording form P and the length of the nip section. According to the present Embodiment, the conveyance speed of the recording form P is maintained constant.

Further, in this Embodiment, since the fixing unit 40 uses the belt nip method wherein only one non-image side pressurization pad 53 is used, there is no gap section between pressurization pads as in the case where there are two or more pressurization pads. Accordingly, there is no pressure drop in the nip section 45. In this way, the toner can be fixed in a shorter nip time as compared with a configuration wherein two or more pressurization pads are arranged. This configuration contributes to reducing the change of the amount of heat with the paper thickness as compared with a configuration with two or more pads.

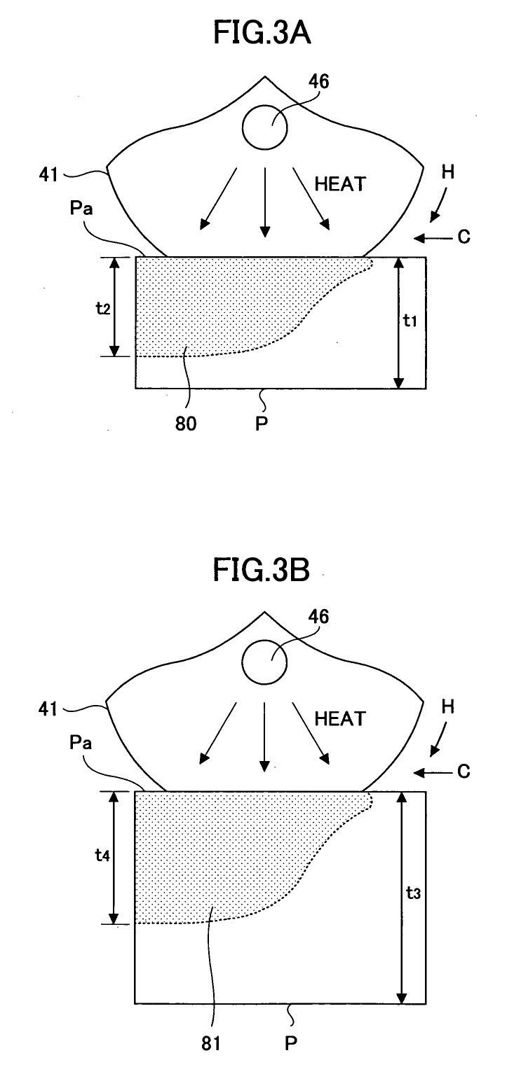

FIG. 3A schematically illustrates a heat transfer situation when fixing the recording form P that is thin (thickness t1=80 μm) for a short nip time. FIG. 3B schematically illustrates the heat transfer situation when fixing the recording form P that is thick (thickness t3=130 μm) for the short nip time.

As shown in FIG. 3A, in the case of thin paper, the heat from the heating roller 41 reaches a depth t2 into the recording form P through the image formation side Pa of the recording form P, and the temperature of a region down to the depth t2 is raised. The temperature-raised region from the image formation side Pa to the depth t2 serves as a heat transfer region 80. Further, a region wherein temperature is raised as compared with the form temperature before entering the fixing unit 40 is called an effective heat transfer region.

As shown in FIG. 3B, in the case of thick paper, the heat from the heating roller 41 reaches a depth t4 into the recording form P through the image formation side Pa of the recording form P, the thickness t3 being greater than the thickness t1, and the temperature of a region down to the depth t4 is raised. The temperature-raised region from the image formation side Pa to the depth t4 serves as a heat transfer region 81.

The depths t2 and t4 down to which the heat permeates within a predetermined time in the heat transfer regions 80 and 81, respectively, are called thermal penetrating depths, and are given by a square root of 12 times a product of a thermal diffusivity and time.

Accordingly, the thermal penetrating depth for various paper thicknesses concerning Embodiments of the present invention is given by a square root of 12 times a product of the thermal diffusivity of the paper and the nip time. Here, the thermal penetrating depth is defined, in the thickness direction of the recording form P from the image formation side Pa, as the greatest distance at which the temperature is raised by one ° C. or more.

Practically, the thermal penetrating depth in toner fixing can be considered to be the square root of the product of the thermal diffusivity of the paper and the nip time as stated by, for example, Japanese Patent 2909499 (Patent Reference 3). When the nip time is short, e.g., about 10 ms, the heat provided by the heating roller does not reach the back of the recording form P in either of the thicknesses shown in FIG. 3A and FIG. 3B. In this case, the paper thickness can be considered the same irrespective of the actual paper thicknesses, being thermally equivalent to an infinite thickness. Accordingly, the amount of heat provided to the toner is the same irrespective of the paper thickness.

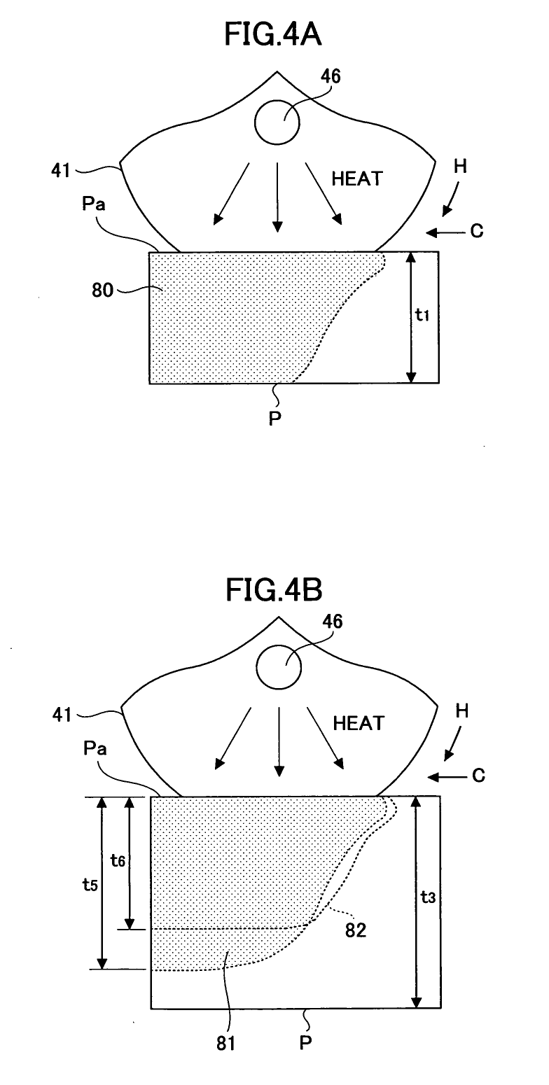

FIG. 4A schematically illustrates the heat transfer situation when fixing the recording form P that is thin for a long nip time. FIG. 4B schematically illustrates the heat transfer situation when fixing the recording form P that is thick for a long nip time.

As shown in FIG. 4A, when the nip time is made longer than in the case shown by FIG. 3A by slowing the paper conveyance speed, the heat from the heating roller 41 reaches the back of the recording form P, which is thin, through the image formation side Pa of the recording form P, and the temperature down to the depth t1 of the recording form P is raised. The temperature raised region from the image formation side Pa to the depth t1 is the heat transfer region 80, which is heated to a setup temperature for fixing the toner.

FIG. 4B shows the case wherein the recording form P is thick and the paper conveyance speed is made low by lengthening the nip time as compared with the case shown in FIG. 3B. In this case, the heat from the heating roller 41 reaches a depth t5 into the recording form P through the image formation side Pa, and the temperature is raised through the depth t5 of the recording form P. The temperature raised region from the image formation side Pa to the depth t5 is the heat transfer region 81.

Further, in FIG. 4B, a region 82 shown with a dashed line is a profile of the heat transfer region 80 in the case of the thin paper.

Comparing the heat transfer region 80 of the thin paper as shown in FIG. 4A with the heat transfer region 81 of the thick paper as shown in FIG. 4B, the heat reaches the back of the recording form P in the case of the thin paper, having a different profile from the heat transfer region as compared with the thick paper, the heat transfer range is smaller with the thick paper at an interface with the heating roller 41 where the toner is present, and, therefore, the amount of heat provided to the toner is smaller with the thick paper. For this reason, with the thick paper, in order to provide the toner with the same amount of heat as the toner on the thin paper, it is necessary to provide a greater amount of heat to the recording form P.

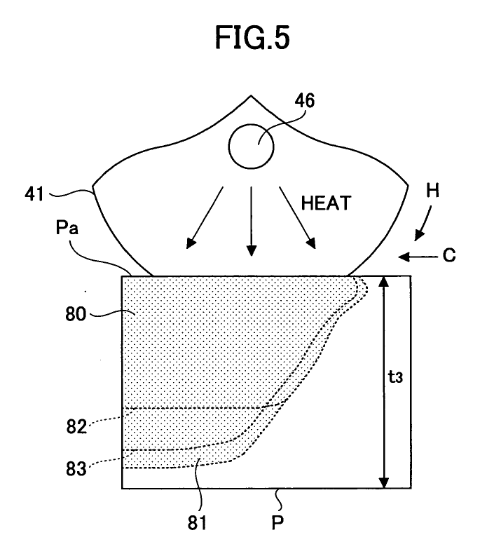

FIG. 5 illustrates heat transfer when the nip time is lengthened in the case of the thick paper. Lengthening the nip time is equivalent to providing more heat to the recording form P. A region 83 shown in FIG. 5 by a dashed line represents the profile of the heat transfer region 81 of the thick paper shown by FIG. 4B.

As shown in FIG. 5, near the interface with the heating roller 41, the same profile of the heat transfer region as that of the thin paper is obtained for the thick paper by lengthening the nip time. In this way, when the thermal effective penetrating depth exceeds the paper thickness, the nip time has to be lengthened so that the amount of heat provided to the toner can be made constant according to the conventional method. That is, in order to provide the toner on the thick paper with the same amount of heat as the toner on the thin paper, it is necessary to provide more heat to the recording form P.

Next, an offset property of the toner concerning the fixing unit 40 is described with reference to FIG. 6, which is a graph showing the relationship between the temperature of the heating roller 41 and the amount of offset toner. As shown in FIG. 6, the amount of offset toner takes the shape of a character “U” depending on the temperature of the heating roller 41. A temperature range wherein the amount of offset is the greater and a temperature range wherein the amount of offset is the smaller are determined by experiments.

In the graph shown in FIG. 6, the horizontal axis represents the temperature of the heating roller 41, and the vertical axis represents the amount of offset toner. A range between temperatures T2 and T3 produces the smallest amount of toner offset, and is a non-offsetting range 91. Further, a temperature range lower than the non-offsetting range 91, i.e., lower than the temperature T2, is a low temperature range 92; and a temperature range higher than the non-offsetting range 91, i.e., higher than the temperature T3, is a high temperature range 93.

Accordingly, the graph shows that the amount of offset toner increases in the low temperature range 92 and the high temperature range 93. Here, the offset produced in the low temperature range 92 is called low temperature offset, and the offset produced in the high temperature range 93 is called high temperature offset.

Furthermore, a boundary range (temperature range between T1 and T2) on the low temperature side of the non-offsetting range 91 is called an inconspicuous offset range 94, and a boundary range (temperature range between T3 and T4) on the high temperature side of the non-offsetting range 91 is called an inconspicuous offset range 95. In the inconspicuous offset ranges 94 and 95, the amount of offset toner is slightly greater than the non-offsetting range 91; however, since the amount of offset is small, the offset is not visible.

In general, a problem is in that the offset toner adhering to the heating roller 41 is transferred to the recording form P, causing incorrect printing. However, if the offset toner incorrectly transferred to the recording form P is not discernible as an image, it is considered that the problem is not present. That is, the problem of incorrect printing by offset toner is not produced in the inconspicuous offset ranges 94 and 95.

Nevertheless, even if incorrect printing is not visually discernible when printed in one of the inconspicuous offset ranges 94 and 95, the toner cleaner 47 still has to collect some amount of offset toner. If printing is continued for a great number of sheets, the toner cleaner 47 has to remove a great amount of the offset toner, and has to be replaced in a very short period, which poses a problem.

Specifically, the number of sheets printed, for which the toner cleaner 47 is to be replaced, is thousands; accordingly, printing dozens of sheets in the inconspicuous offset ranges 94 and 95 does not overly shorten toner cleaner service life.

Next, an example is described, wherein the heating temperature of the heating roller 41 is selected according to the thickness of the recording form P such that the temperature may fall into one of the inconspicuous offset ranges 94 and 95.

FIG. 7 is a table showing relationships of the heating roller temperature and the amount of offset produced on thin paper and thick paper concerning the image formation apparatus 10. In FIG. 7, ◯ indicates that there is no offset, Δ indicates that there is an inconspicuous offset, and X indicates that there is a conspicuous offset. As shown in FIG. 7, in the case of the thin paper, the non-offsetting range 91 is between 150° C. and 180° C.; and temperatures 140° C. and 190° C. are the inconspicuous offset ranges 94 and 95, respectively. Further, in the case of the thick paper, the non-offsetting range 91 is between 180° C. and 210° C.; and temperatures 170° C. and 220° C. are the inconspicuous offset ranges 94 and 95, respectively.

According to Embodiment 1, the fixing unit 40 uses the belt nip method wherein the nip time is comparatively long at 100 ms. Accordingly, the amount of heat provided to the toner differs with the thickness of the paper for the same temperature. Therefore, the temperatures delimiting the non-offsetting range 91 also differ. In the case of thin paper, the temperature of the heating roller 41 is 170° C. In the case of thick paper, given that the nip time is common to the thin paper and the thick paper, it is necessary to raise the temperature of the heating roller 41. For this reason, the temperature of the heating roller 41 is 190° C. for the thick paper. That is, the temperature is set within the non-offset range.

The temperature of the heating roller 41 is adjusted not only to make the amount of heat provided to the toner constant, but also to take into consideration the offset property. It is desired that the temperature of the heating roller 41 be such that the amount of heat provided to the toner be equal both in the cases of the thick paper and thin paper and at the center of the non-offset range as much as possible.

The temperature of the heating roller 41 that provides an amount of heat to the toner on the thick paper, the amount being the same as provided by 170° C. to the thin paper, is 200° C. However, the temperature for the thick paper is set at 190° C. according to Embodiment 1. This is to obtain a smooth shift between the thin paper and the thick paper.

That is, when the recording form is changed from thick paper to thin paper, since the temperature of the heating roller 41 has been controlled for the thick paper at 190° C., the first sheet of the thin paper is processed at a temperature near 190° C. In this case, since the temperature of the heating roller 41 is in the inconspicuous offset range 95 for the thin paper, the offset is inconspicuous.

In reverse, when the recording form is changed from thin paper to thick paper, since the temperature of the heating roller 41 has been controlled at 170° C. for the thin paper, the first sheet of the thick paper is processed at a temperature near 170° C. In this case, since the temperature of the heating roller 41 is in the inconspicuous offset range 94 for the thick paper, the offset is inconspicuous.

Here, if the temperature of the heating roller 41 is set at 200° C. so that the thick paper receives the same amount of heat as the thin paper receives, the first sheet of the thin paper is processed at a temperature near 200° C. This temperature is higher than the inconspicuous offset range 95, and, therefore, a visible offset may occur.

According to the image formation apparatus 10 of Embodiment 1, when the recording form is changed from thin paper to thick paper, the temperature 170° C. for the thin paper is increased to 190° C. for the thick paper. It takes 15 continuous sheets before the temperature of the heating roller 41 reaches 190° C.

In reverse, when the recording form is changed from thick paper to thin paper, the temperature 190° C. for the thick paper is lowered to 170° C. for the thin paper. It takes 10 continuous sheets before the temperature of the heating roller 41 reaches 170° C. In this way, the number of sheets that are processed at a temperature in the inconspicuous offset ranges 94 and 95 is as small as 15 or less, so that the period of cleaner replacement is not overly shortened.

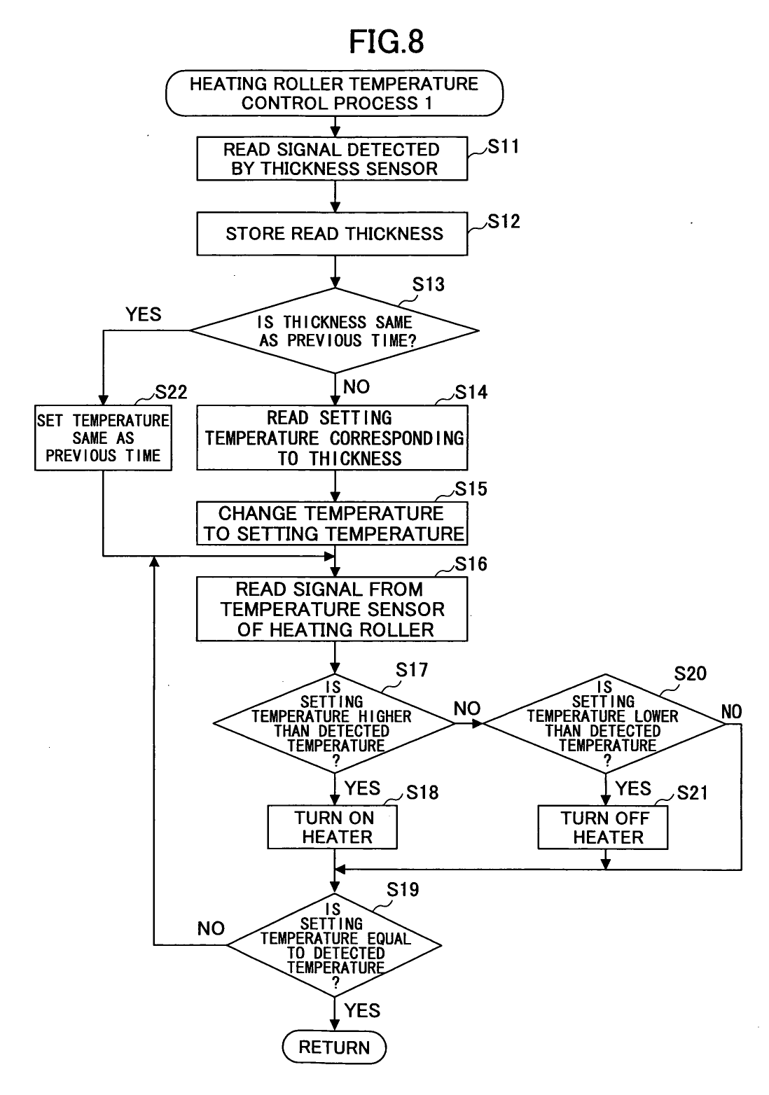

A heating roller temperature control process 1 performed by the control unit 19 is described with reference to a flowchart given in FIG. 8. At Step S11 (the word “Step” may be omitted in the following) in FIG. 8, a detected signal is read from the thickness sensor 36, the detected signal representing the paper thickness of the recording form P provided by the form cassette 20. Next at S12, the paper thickness is determined based on the value of the detected signal provided by the thickness sensor 36, and the determined paper thickness is stored in the storage section 19a.

Then, at S13, it is determined whether the paper thickness of the recording form P that is pulled out from the form cassette 20 is the same as the paper thickness of an immediately previous recording form P. If the paper thickness of the recording form P pulled out from the form cassette 20 differs from the paper thickness of the immediately previous recording form P, the process progresses to S14. At S14, a temperature that is in the inconspicuous offset range of the current recording form P is extracted from the storage section 19a (as for Embodiment a, 170° C. when changing from thin paper to thick paper, and 190° C. when changing from thick paper to thin paper).

Then, at S15, the temperature of the heating roller 41 is adjusted to the setup temperature corresponding to the paper thickness (setting means). Further, the timing of changing the temperature is just before the recording form P, the thickness of which is detected by the thickness sensor 36, reaches the nip section 45 of the heating roller 41.

Then, at S16, the temperature of the heating roller 41 detected by the temperature sensor 37 is read, and at S17, it is determined whether the detected temperature agrees with the setup temperature. If the detected temperature is lower than the setup temperature, the process progresses to S18, wherein a voltage applied to the electric heater 46 is maintained ON. Then, at S19, when the detected temperature becomes equal to the setup temperature, the process returns to S11. Here, although the setup temperature according to Embodiment is one of 170° C. and 190° C., the setup temperature may be defined by a range such as 170±5° C. and 190±5° C.

In the case that the detected temperature is not lower than the setup temperature at S17, the process progresses to S20, wherein it is determined whether the detected temperature is higher than the setup temperature. At S20, if the detected temperature is higher than the setup temperature, the voltage applied to the electric heater 46 is turned OFF, and the process proceeds to S19.

In this way, the voltage applied to the electric heater 46 is controlled such that the detected temperature of the heating roller 41 becomes equal to the setup temperature (i.e., 170° C. when changing from thin paper to thick paper, and 190° C. when changing from thick paper to thin paper).

At S13, if the paper thickness of the recording form P that is pulled out from the form cassette 20 is the same as the paper thickness of the immediately preceding recording form P, the process progresses to S22, where the same temperature as the previous time is set, and steps S16 and on are performed.

As described above, according to the image formation apparatus 10 of Embodiment 1, the nip time is kept constant at 100 ms, i.e., the nip time does not have to be changed with paper thickness, thus producing no incorrect printing due to offsetting. Since the nip time is made constant for different paper thicknesses, the printing speed is constant. For this reason, high-speed printing without degrading productivity when printing on thick paper is obtained.

Further, since, according to the image formation apparatus 10 of Embodiment 1, the printing speed is made constant, the form conveyance speed of a final imprinting process and a fixing process can always be made equal. For this reason, the distance from the final imprint unit to the fixing unit can be made shorter than the form length in the conveyance direction. Accordingly, the image formation apparatus 10 can be made small, and can be installed in a small space where the conventional image formation apparatus may not fit.

Although Embodiment 1 above refers to the case wherein the printing speed and the nip time are constant, an implementation is possible wherein the printing speed and/or the nip time are changed, in addition to changing the temperature as described above. Such implementation also offers an image formation apparatus 10 that is capable of improved reliability and availability, as compared with the conventional image formation apparatus, because frequency of changes of imprinting speed and/or nip time is reduced.

[Embodiment 2]

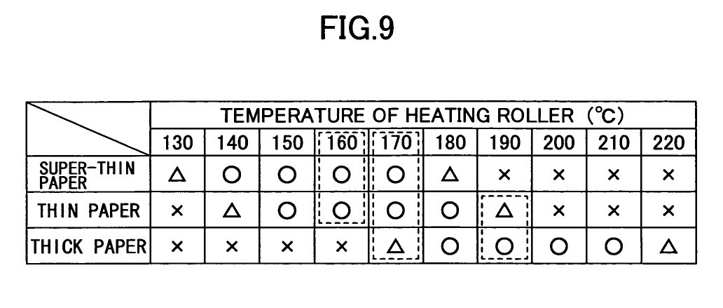

Next, another embodiment, Embodiment 2 of the present invention is described with reference to FIG. 9, which is a table showing relationships between the heating roller temperature and the amount of offset produced in the cases of processing super-thin paper, thin paper, and thick paper by the image formation apparatus 10 of this Embodiment.

In FIG. 9, ◯ indicates that no offset is produced; Δ indicates that an inconspicuous offset is produced; and X indicates that a conspicuous offset is produced. As for the super-thin paper, the non-offsetting range 91 is between 140° C. and 170° C.; further, 130° C. and 180° C. are in the inconspicuous offset ranges 94 and 95, respectively. Here, as for the cases of the thin paper and the thick paper, the same as described above with reference to FIG. 7 applies.

Since the configuration of the image formation apparatus 10 and the fixing unit 40 of Embodiment 2 are the same as those of Embodiment 1, the descriptions thereof are not repeated. In Embodiment 2, the temperature is adjusted for the super-thin paper (having a thickness of, for example, about 50 μm), which is thinner than the thin paper, which is the difference from Embodiment 1.

The setup temperatures for the thin paper and the thick paper are the same as Embodiment 1. The temperature of the heating roller 41 for the super-thin paper is 160° C. Since the temperature of the heating roller 41 for the thin paper is 170° C., which is the same as Embodiment 1, the temperature change between the super-thin paper and the thin paper in either direction can be performed in the non-offsetting range 91. Accordingly, there is no problem of producing incorrect printing or shortening cleaner replacement interval.

However, in the case of changing to super-thin paper from thick paper, and vice versa, the difference of temperature is greater than the case of changing between the thin paper and the thick paper. Therefore, the heating roller temperature for the super-thin paper is controlled at 160° C. in Embodiment 2. Nevertheless, if the thick paper is processed at the temperature 160° C. that is appropriate for the super-thin paper, a conspicuous offset is produced on the thick paper, because the temperature 160° C. of the heating roller 41 is in the low-temperature area 92 and is lower than the inconspicuous offset range 94 for the thick paper.

Even if it is attempted to change the temperature simultaneously with the paper thickness change, the temperature of the heating roller 41 cannot be immediately raised. For this reason, a conspicuous offset is produced if the thick paper is processed simultaneously with the paper thickness change.

In order to cope with this, according to Embodiment 2, printing is prevented until the temperature reaches 170° C., which temperature of the heating roller 41 belongs to the inconspicuous offset range 94 for the thick paper. By starting printing when the temperature reaches 170° C., no conspicuous offset is produced. Then, the heating roller temperature soon reaches 190° C. Accordingly, printing in the inconspicuous offset range does not last long, minimizing the influence on the cleaner replacement interval.

Further, if the super-thin paper is processed by the fixing unit 40 at the temperature 190° C., which is appropriate for the thick paper, since the temperature of the heating roller 41 is in the high temperature range 93 above the inconspicuous offset range 95 for the super-thin paper, a conspicuous offset is produced on the super-thin paper. Accordingly, even if it is attempted to change the temperature simultaneously with the paper thickness change, the temperature is not immediately lowered, and a conspicuous offset is produced on the super-thin paper.

In order to cope with this, according to Embodiment 2, printing is prevented until the temperature of the heating roller 41 descends to 180° C., which is in the inconspicuous offset range 95 for the super-thin paper. By starting printing when the temperature of the heating roller 41 becomes 180° C., no conspicuous offset is produced. Then, the heating roller temperature soon reaches 140° C., so that printing in the inconspicuous offset range does not last long. Accordingly, the replacement interval of the cleaner is not overly shortened.

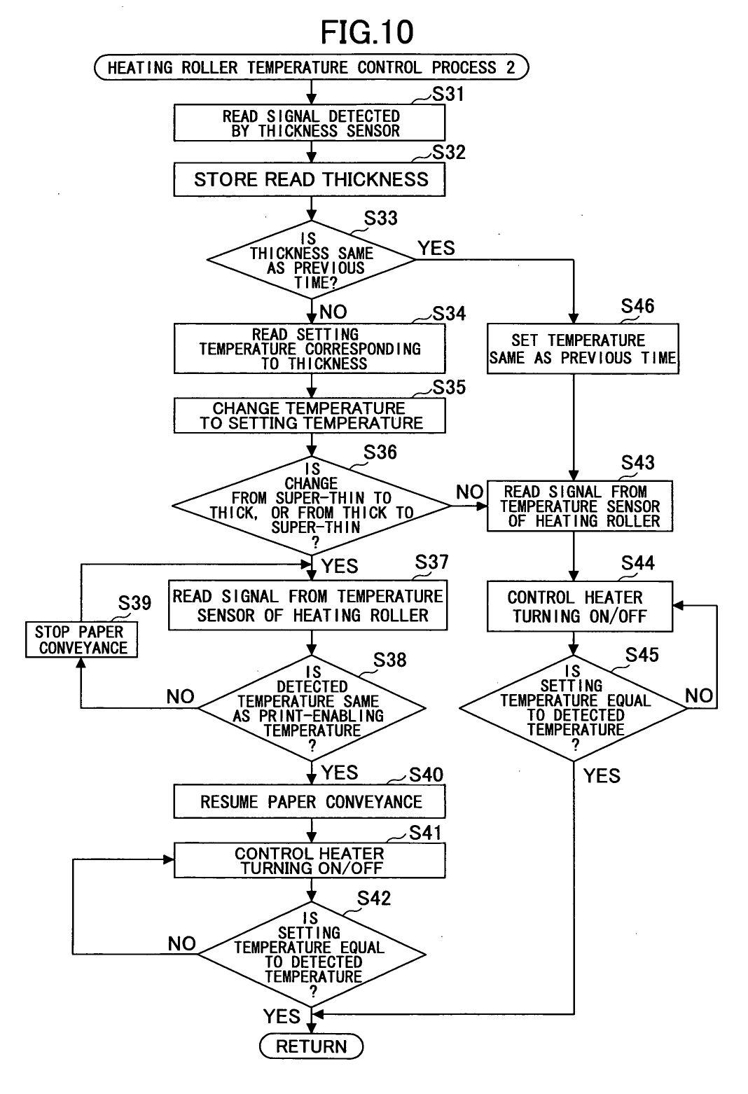

Next, a heating roller temperature control process 2 performed by the control unit 19 is described with reference to a flowchart given in FIG. 10. Since steps S31 through S35 shown in FIG. 10 are respectively the same as the steps S11 through S15 described with reference to FIG. 8, the descriptions thereof are not repeated. As for functional units, they are the same as described above with reference to FIG. 1.

At S36, the paper thickness detected last time is compared with the paper thickness detected this time, and it is determined whether the change is between the super-thin paper and thick paper in either direction. If the determination is affirmative, the process progresses to S37 wherein the temperature of the heating roller 41 detected by the temperature sensor 37 is read. Then, at S38, it is determined whether the detected temperature has reached a predetermined print-enabling temperature for the new paper thickness (170° C. or 180° C. according to Embodiment 2). The print-enabling temperature is 170° C. if the change is from super-thin paper to thick paper and 180° C. if the change is from thick paper to super-thin paper. Here, at S38, it is determined whether the detected temperature has reached one of the print-enabling temperatures, the one being selected according to the paper thickness to which the change is made.

If the determination at S38 is that the detected temperature has not reached the selected print-enabling temperature (170° C. or 180° C.), the process progresses to S39 wherein conveyance of the recording form P is temporarily stopped. Conveyance and printing will be resumed when the temperature of the heating roller 41 reaches the selected print-enabling temperature such that no conspicuous offset may be produced in the cases of changing the paper thickness from super-thin paper to thick paper, and vice versa, as described below. After this, the process returns to S37, and the steps S37 through S39 are repeated.

If it is determined at S38 that the detected temperature has reached the print-enabling temperature (170° C. or 180° C.) for the new paper thickness, the process progresses to S40 wherein the conveyance of the recording form P is resumed. Then, at S41, the voltage provided to the electric heater 46 is controlled, turned on and off, such that the detected temperature of the heating roller 41 becomes equal to the setup temperature.

Next, at S42, it is determined whether the temperature has reached the setup temperature, namely, 160° C. for super-thin paper, 170° C. for thin paper, and 190° C. for thick paper, which setup temperatures are in the non-offset range. If the determination at S42 is that the detected temperature has not reached the setup temperature, the process returns to S41 such that the voltage applied to the electric heater 46 is turned on or off, as required, so that the detected temperature of the heating roller 41 becomes the setup temperature. If the determination at S42 is that the detected temperature has reached the setup temperature, the process is finished and returns to S31.

Further, in the case wherein the determination at S36 is negative (that is, change in paper thickness is not between the super-thin paper and the thick paper in either direction), the temperature difference for the change is not great, and no conspicuous offset is produced. Accordingly, the paper conveyance is not stopped, but the process progresses to S43, wherein the temperature of the heating roller 41 detected by the temperature sensor 37 is read. Then, next at S44, the voltage applied to the electric heater 46 is turned on or off, as required, such that the detected temperature of the heating roller 41 becomes equal to the setup temperature.

Then, the process progresses to S45, wherein it is determined whether the detected temperature has reached an applicable one of the setup temperatures (namely, 160° C. for the super-thin paper, 170° C. for the thin paper, and 190° C. for the thick paper), the setup temperatures being in the respective non-offset ranges. If it is determined at S45 that the detected temperature has reached the setup temperature, the process is finished and returns to S31.

Therefore, the temperature is first brought to the inconspicuous offset range corresponding to the three kinds of the recording forms P having different paper thickness (super-thin paper, thin paper, and thick paper), and in this way, no conspicuous offset is produced when the paper thickness is changed, providing reliable, productive, and high-speed printing.

As described above, according to this Embodiment, when the recording form P is changed from super-thin paper to thick paper, or from thick paper to super-thin paper, since the difference between the current temperature and the temperature to-be-changed-to i.e., destination temperature, is great, the conveyance of the recording form P is temporarily stopped until the detected temperature reaches the print-enabling temperature (170° C. or 180° C. as applicable) at which no conspicuous offset is produced. When the detected temperature of the heating roller 41 reaches the print-enabling temperature (170° C. or 180° C.), the conveyance of the recording form P is resumed, and printing without a conspicuous offset is carried out.

According to Embodiment 2 as described above, the nip time, which is as long as 100 ms, is kept constant for all the thick paper, the thin paper, and the super-thin paper, and there is no incorrect printing by the offset. Since the nip time does not have to be changed, the print speed is maintained, and the printing productivity is maintained for the thick paper. Further, since the distance from the final imprint unit to the fixing unit can be made shorter than the form length in the conveyance direction, the image formation apparatus 10 according to Embodiment 2 can be made small, and can be installed in a small space where a conventional image formation apparatus may not fit.

Further, the present invention is not limited to these embodiments, but variations and modifications may be made without departing from the scope of the present invention.

The present application is based on Japanese Priority Application No. 2005-278378 filed on Sep. 26, 2005 with the Japanese Patent Office, the entire contents of which are hereby incorporated by reference.

What is claimed is:

1. An image formation apparatus, comprising:
an image forming unit for forming a toner image on a recording object; and
a fixing unit for fixing the toner image to the recording object, the fixing unit using a belt nip method and including a heating roller; wherein
a temperature of the heating roller is set within a non-offsetting range corresponding to a thickness of the recording object, and
when the thickness of the recording object is changed, a first sheet of the recording object after thickness changing is fixed while the temperature of the heating roller is in an inconspicuous offset range that is adjacent to the non-offsetting range.

2. The image formation apparatus as claimed in claim 1, wherein
a nip time of the fixing unit is defined such that a square root of a product of a thermal diffusivity of the recording object and the nip time is greater than the thickness of the recording object.

3. The image formation apparatus as claimed in claim 2, wherein the nip time of the fixing unit is a constant when changing the thickness of the recording object.

4. An image formation apparatus, comprising:
an image forming unit for forming a toner image on a recording object; and
a fixing unit for fixing the toner image to the recording object, the fixing unit using a belt nip method and including a heating roller; wherein
a temperature of the heating roller is set within a non-offsetting range corresponding to a thickness of the recording object,
when the thickness of the recording object is changed, a first sheet of the recording object after thickness changing is fixed while the temperature of the heating roller is in an inconspicuous offset range that is adjacent to the non-offsetting range, and
a distance from a final imprinting unit to the fixing unit is smaller than a length of the recording object in a direction of conveyance.

5. The image formation apparatus as claimed in claim 1, wherein
a non-image side pressurization member of the fixing unit of the belt nip method is singular.
